(19) United States
(12) Patent Application Publication
(10) Pub. No.: US 2026/0146867 A1
(43) Pub. Date: May 28, 2026

(54) LARGE PRE-TRAINED NEURAL NETWORKS FOR ONLINE MAP GENERATION AND AUTO-LABELING

(71) Applicant: Robert Bosch GmbH, Stuttgart (DE)

(72) Inventors: David Fernando PAZ RUIZ, Sunnyvale, CA (US); Yuliang GUO, Redwood City, CA (US); Xinyu HUANG, San Jose, CA (US); Liu REN, Saratoga, CA (US)

(21) Appl. No.: 18/958,062

(22) Filed: Nov. 25, 2024

(51) Int. Cl. G01C 21/00; B60W 60/00; G06V 10/82; G06V 20/56

(52) U.S. Cl. CPC G01C 21/387; B60W 60/001; G01C 21/3833; G01C 21/3885; G06V 10/82; G06V 20/56; B60W 2420/403; B60W 2556/35; B60W 2556/40

(57) ABSTRACT

A method of generating high definition (HD) maps for a vehicle based on standard definition (SD) maps includes, using a processor, receiving an SD map corresponding to an environment, receiving one or more aerial images corresponding to the environment, predicting and labeling features contained within the SD map using at least one pairing of the SD map and a respective aerial image of the one or more aerial images, generating a first HD map based on the predicted and labeled features contained within the SD map and the one or more aerial images, and transmitting the first HD map to the vehicle for use in controlling autonomous driving functions.

### TECHNICAL FIELD

The present disclosure relates to methods and systems for generating high definition (HD) maps at a vehicle (i.e., “online”) using a standard definition (SD) map and a pre-trained model.

### BACKGROUND

An autonomous vehicle, often referred to as a self-driving or driverless vehicle, is a type of vehicle capable of navigating and operating on roads and in various environments without direct human control. Autonomous vehicles use a combination of advanced technologies and sensors to perceive their surroundings, make decisions, and execute driving tasks.

Autonomous vehicles are typically equipped with a variety of sensors, including LiDAR, radar, cameras, ultrasonic sensors, and sometimes additional technologies like GPS and IMUs (Inertial Measurement Units). These sensors provide real-time data about the vehicle's surroundings, including the positions of other vehicles, pedestrians, road signs, and road conditions. The vehicle's onboard computers use data from sensors to create a detailed map of the environment and to perceive objects and obstacles. This information is essential for navigation and collision avoidance.

### SUMMARY

A method of generating high definition (HD) maps for a vehicle based on standard definition (SD) maps includes, using a processor, receiving an SD map corresponding to an environment, receiving one or more aerial images corresponding to the environment, predicting and labeling features contained within the SD map using at least one pairing of the SD map and a respective aerial image of the one or more aerial images, generating a first HD map based on the predicted and labeled features contained within the SD map and the one or more aerial images, and transmitting the first HD map to the vehicle for use in controlling autonomous driving functions.

Other embodiments include a non-transitory computer readable storage medium configured to store instructions that, when executed by a processor included in a computing device, cause the computing device to carry out the various steps of any of the foregoing methods. Further embodiments include a computing device or system that is configured to carry out the various steps of any of the foregoing methods. Further embodiments include a machine that is configured to carry out the various steps of any of the foregoing methods.

Other aspects and advantages of the invention will become apparent from the following detailed description taken in conjunction with the accompanying drawings that illustrate, by way of example, the principles of the described embodiments.

### BRIEF DESCRIPTION OF THE DRAWINGS

FIG. 1 shows a system for training a neural network according to the principles of the present disclosure.

FIG. 2 shows a computer-implemented method for training and utilizing a neural network according to the principles of the present disclosure.

FIG. 3 shows a schematic diagram of a control system configured to control a vehicle, which may be a partially autonomous vehicle, a fully autonomous vehicle, a partially autonomous robot, or a fully autonomous robot according to the principles of the present disclosure.

FIG. 4 shows a schematic overview of a system for generating a high definition (HD) map and lane-level trajectory based on a standard definition (SD) map and sensor data according to the principles of the present disclosure.

FIG. 5 shows a schematic of information provided in an SD map according to the principles of the present disclosure.

FIG. 6A shows an example system configured to implement an LPNN to generate an online HD map according to the principles of the present disclosure.

FIG. 6B shows the HD map generator of FIG. 6A in more detail according to the principles of the present disclosure.

FIG. 7 shows an example system configured to train and implement an online map generator according to the principles of the present disclosure.

FIG. 8 illustrates steps of an example method for performing HD map generation according to the principles of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

Rapid advancements in autonomous driving technology have ushered in a new era of transportation, promising safer and more efficient journeys. Autonomous driving systems generally include three high-level tasks: (1) perception, (2) prediction, and (3) planning. Perception involves the vehicle's ability to understand and interpret its environment. This task includes various sub-components like computer vision, sensor fusion, and localization. Key elements of perception include object detection (e.g., identification and tracking agents external to the autonomous vehicle), localization (e.g., determining the vehicle's precise position and orientation in the world, often using GPS and other sensors), and sensor fusion (e.g., combining data from different sensors, such as cameras, LiDAR, radar, and ultrasonic sensors to build a comprehensive view of the surroundings). Prediction involves anticipating how other road users and agents in the environment will behave in the near future. This task often involves using machine learning models to estimate the trajectories and intentions of the agents, including pedestrians, other vehicles, and potential obstacles. Accurate prediction is crucial for making safe driving decisions. Planning involves determining the optimal path and actions for the autonomous vehicle to navigate its environment. The planner (also referred to as the planner module or planner model) is an autonomous driving software stack that is responsible for planning the trajectory of the autonomous vehicle. This typically includes tasks like route planning, trajectory planning, and decision-making. The planning system considers information from perception and prediction to make decisions such as when to change lanes, when to stop at an intersection, how to react to unexpected events, and the like.

Autonomous driving applications for urban and highway driving applications often require high definition (HD) and dense map representations to be able to generate a point-to-point navigation plan. These maps provide detailed and accurate information about the road geometry, lane markings, traffic signs, and other relevant data. Autonomous vehicles use these maps along with real-time sensor inputs to navigate safely and make informed prediction determinations and planning decisions. HD maps are generated off-the vehicle board (i.e., “offline”) and either pre-loaded onto the vehicle's onboard storage system or transmitted wirelessly to the vehicle through communication channels such as 4G, 5G, or other dedicated communication networks. This approach allows for real-time updates and ensures that vehicles have access to the latest map information. However, various challenges arise when maintaining and generating HD maps are at scale. For instance, in heavily dynamic environments and active construction sites, the previously defined maps can be displaced and outdated and as result require continuous updates. The HD map generation and updating tasks often require human labeling and validation teams that present constraints for large scale autonomous driving applications.

To address these limitations, HD map generations systems and methods according to the present disclosure are configured to provide functionality for auto-label generation for online mapping topics and introducing improved lightweight prior representations (e.g., neural scene priors) or maps (e.g., SD maps) during onboard vehicle (i.e., “online”) execution. In one example implementation, a real-time road network model including all the features provided by offline HD maps may be used to generate HD map representations (e.g., vectorized, rasterized representations) and reference trajectories onboard the vehicle that can be utilized by downstream planner components. In some examples, this implementation includes the use of real-time perception data from the vehicle sensors mounted on the vehicle with the sparse and lightweight prior maps that are widely available and scalable. This approach is capable of generating lane-level trajectories that can be ingested by behavioral and motion planners. An example of this implementation is described in more detail in U.S. patent application Ser. No. 18/428,586, the entire contents of which are incorporated herein by reference. HD map generations systems and methods according to the present disclosure build upon these techniques by implementing a pre-trained model configured to generate an initial HD map estimate for offline auto-labeling of ground-truth data and providing improved SD map representations for the online map generation task (e.g., by reusing encoders associated with the pre-trained model).

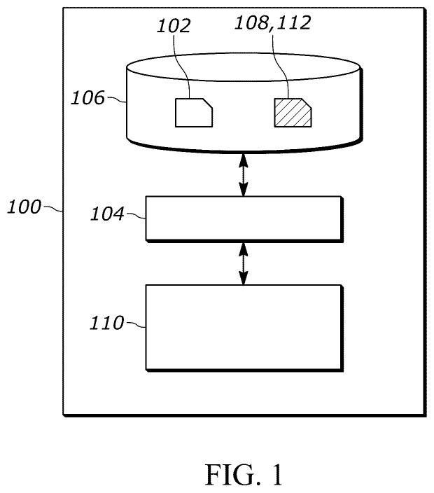

Machine learning and neural networks are an integral part of autonomous vehicles and embodiments of the invention disclosed herein. FIG. 1 shows a system 100 for training a neural network, e.g. a deep neural network. The system 100 may comprise an input interface for accessing training data 102 for the neural network. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the neural network which may be accessed by the system 100 from the data storage 106. It will be appreciated, however, that the training data 102 and the data representation 108 of the untrained neural network may also each be accessed from a different data storage, e.g., via a different subsystem of the data storage interface 104. Each subsystem may be of a type as is described above for the data storage interface 104. In other embodiments, the data representation 108 of the untrained neural network may be internally generated by the system 100 on the basis of design parameters for the neural network, and therefore may not explicitly be stored on the data storage 106.

The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive, as input, an output of a previous layer, or for a first layer of the stack of layers, an initial activation and a part of the input of the stack of layers. The processor subsystem 110 may be further configured to iteratively train the neural network using the training data 102. Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network. The system 100 may further comprise an output interface for outputting a data representation 112 of the trained neural network; this data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ neural network may, during or after the training, be replaced at least in part by the data representation 112 of the trained neural network, in that the parameters of the neural network, such as weights, hyperparameters and other types of parameters of neural networks, may be adapted to reflect the training on the training data 102. This is also illustrated in FIG. 1 by the reference numerals 108, 112 referring to the same data record on the data storage 106. In other embodiments, the data representation 112 may be stored separately from the data representation 108 defining the ‘untrained’ neural network. In some embodiments, the output interface may be separate from the data storage interface 104, but may in general be of a type as described above for the data storage interface 104.

The system 100 shown in FIG. 1 is one example of a system that may be utilized to train the machine learning models described herein.

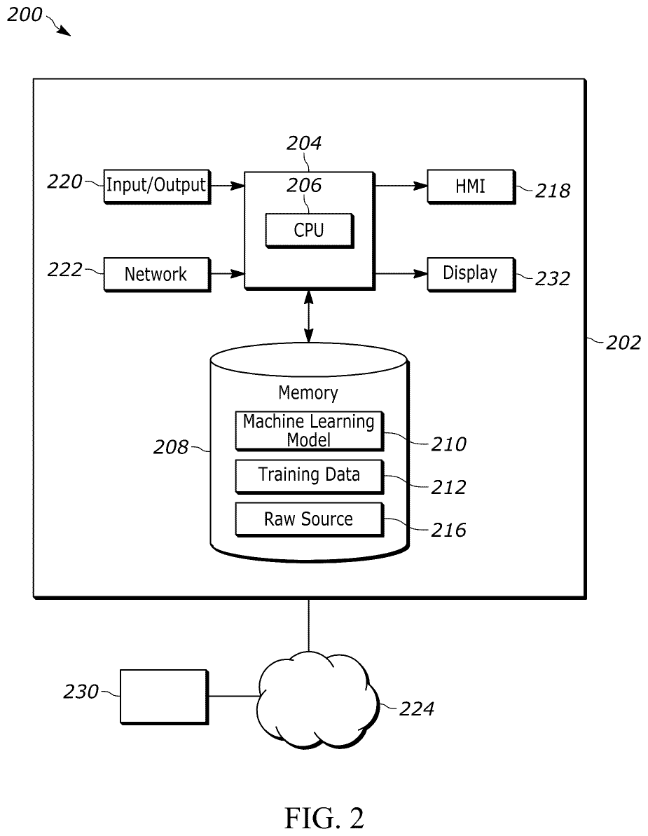

FIG. 2 depicts a system 200 to implement the machine-learning models described herein. The system 200 may include at least one computing system 202. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction set such as one of the x86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system on a chip (SoC) that integrates functionality of the CPU 206, the memory unit 208, a network interface, and input/output interfaces into a single integrated device. The computing system 202 may implement an operating system for managing various aspects of the operation. While one processor 204, one CPU 206, and one memory 208 is shown in FIG. 2, of course more than one of each can be utilized in an overall system.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning model 210 or algorithm, a training dataset 212 for the machine-learning model 210, raw source dataset 216.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud. This allows for the transmission of SD map data and HD map data to the vehicle, for example (even though as will be explained further below, in embodiments the HD map is generated online at the vehicle rather than transmitted to the vehicle via the network interface device).

The external network 224 may be referred to as the world-wide web or the Internet. The external network 224 may establish a standard communication protocol between computing devices. The external network 224 may allow information and data to be easily exchanged between computing devices and networks. One or more servers 230 may be in communication with the external network 224. These servers 230 may be configured to generate SD map data and HD map data, for example. In embodiments, the SD map is generated by and at the server 230 and transmitted via network 224 to a computing system 202 on the vehicle, whereby the computing system 202 on the vehicle creates an HD map, lane trajectories, etc. online at the vehicle based on the transmitted SD map and perception data, thereby allowing the HD map to be created online and based on live data rather than being generated at the server 230 and updated therefrom.

The computing system 202 may include an input/output (I/O) interface 220 that may be configured to provide digital and/or analog inputs and outputs. The I/O interface 220 is used to transfer information between internal storage and external input and/or output devices (e.g., HMI devices). The I/O 220 interface can includes associated circuity or BUS networks to transfer information to or between the processor(s) and storage. For example, the I/O interface 220 can include digital I/O logic lines which can be read or set by the processor(s), handshake lines to supervise data transfer via the I/O lines, timing and counting facilities, and other structure known to provide such functions. Examples of input devices include a keyboard, mouse, sensors, touch screen, etc. Examples of output devices include monitors, touchscreens, speakers, head-up displays, vehicle control systems, etc. The I/O interface 220 may include additional serial interfaces for communicating with external devices (e.g., Universal Serial Bus (USB) interface). The I/O interface 220 can be referred to as an input interface (in that it transfers data from an external input, such as a sensor), or an output interface (in that it transfers data to an external output, such as a display).

The computing system 202 may include a human-machine interface (HMI) device 218 that may include any device that enables the system 200 to receive control input. The computing system 202 may include a display device 232. The computing system 202 may include hardware and software for outputting graphics and text information to the display device 232. The display device 232 may include an electronic display screen, projector, speaker or other suitable device for displaying information to a user or operator. In the context of a vehicle, the display device 232 may be a touch screen or head-up display for example. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

The system 200 may implement a machine-learning algorithm 210 that is configured to analyze the raw source dataset 216. The raw source dataset 216 may include raw or unprocessed sensor data (e.g., perception data) that may be representative of an input dataset for a machine-learning system. The raw source dataset 216 may include video, video segments, images, text-based information, audio or human speech, time series data (e.g., a pressure sensor signal over time), and raw or partially processed sensor data (e.g., radar map of objects). In some examples, the machine-learning algorithm 210 may be a neural network algorithm (e.g., deep neural network) that is designed to perform a predetermined function. For example, the neural network algorithm may be configured in automotive applications to identify street signs or pedestrians in images. The machine-learning algorithm(s) 210 may include algorithms configured to operate one or more of the machine learning models described herein.

The computing system 202 may store a training dataset 212 for the machine-learning algorithm 210. The training dataset 212 may represent a set of previously constructed data for training the machine-learning algorithm 210. The training dataset 212 may be used by the machine-learning algorithm 210 to learn weighting factors associated with a neural network algorithm. The training dataset 212 may include a set of source data that has corresponding outcomes or results that the machine-learning algorithm 210 tries to duplicate via the learning process. In this example, the training dataset 212 may include input images that include an object (e.g., a street sign, another vehicle, an intersection, etc.). The input images may include various scenarios in which the objects are identified. The input data may also include vectorized SD map definitions represented as graphs, for example.

The machine-learning algorithm 210 may be operated in a learning mode using the training dataset 212 as input. The machine-learning algorithm 210 may be executed over a number of iterations using the data from the training dataset 212. With each iteration, the machine-learning algorithm 210 may update internal weighting factors based on the achieved results. For example, the machine-learning algorithm 210 can compare output results (e.g., a reconstructed or supplemented image, in the case where image data is the input) with those included in the training dataset 212. Since the training dataset 212 includes the expected results, the machine-learning algorithm 210 can determine when performance is acceptable. After the machine-learning algorithm 210 achieves a predetermined performance level (e.g., 100% agreement with the outcomes associated with the training dataset 212), or convergence, the machine-learning algorithm 210 may be executed using data that is not in the training dataset 212. It should be understood that in this disclosure, “convergence” can mean a set (e.g., predetermined) number of iterations have occurred, or that the residual is sufficiently small (e.g., the change in the approximate probability over iterations is changing by less than a threshold), or other convergence conditions. The trained machine-learning algorithm 210 may be applied to new datasets to generate annotated data. In the context of perception, prediction, and planning models, for each model comparisons can be made between the commanded action of the autonomous vehicle and the outcome based on that commanded action. The models can be trained with an optimizer to reduce this loss (e.g., increase the reward), which can lead to convergence.

The machine-learning algorithm 210 may be configured to identify a particular feature in the raw source data 216. The raw source data 216 may include a plurality of instances or input dataset for which supplementation results are desired. For example, the machine-learning algorithm 210 may be configured to identify the presence of other objects (e.g., other cars, pedestrians, etc.) in video images, annotate the occurrences, and/or command the vehicle to take a specific action (planning) based on the locational data of the detected object (perception) and the predicted future movement/location of the object (prediction). The machine-learning algorithm 210 may be programmed to process the raw source data 216 to identify the presence of the particular features. The machine-learning algorithm 210 may be configured to identify a feature in the raw source data 216 as a predetermined feature (e.g., road sign, pedestrian, etc.). The raw source data 216 may be derived from a variety of sources. For example, the raw source data 216 may be actual input data collected by a machine-learning system. The raw source data 216 may be machine generated for testing the system. As an example, the raw source data 216 may include raw video images from a camera.

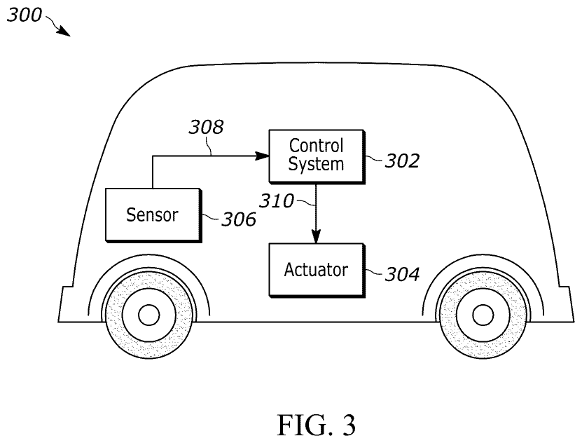

FIG. 3 depicts a schematic diagram of control system 302 configured to control vehicle 300, which may be a partially autonomous vehicle or fully autonomous vehicle, partially autonomous robot or fully autonomous robot. The vehicle 300 and/or its control system 302 can incorporate one or more components of the system 200, such as computing system 202 in order to command an actuator 304 to perform a certain action based upon processing readings from one or more sensors 306. For example, control system 302 can be configured to utilize a planning model in order to control movement of the vehicle via actuator 304, with the planning model being trained via an optimizer. Training can include reinforcement learning as an example.

The one or more sensors 306 may include one or more image sensors (e.g., camera, video sensors, radar sensors, ultrasonic sensors, LiDAR sensors), and/or position sensors (e.g. GPS). The sensors 306 can be configured to generate raw source data 216 indicative of the current state and/or environment associated with the vehicle. One or more of the one or more specific sensors may be integrated into (e.g., mounted, physically connected, etc.) the vehicle 300. In the context of agent recognition and processing as described herein, the sensor 306 is a camera mounted to or integrated into the vehicle 300. Alternatively or in addition to one or more specific sensors identified above, sensor 306 may include a software module configured to, upon execution, determine a state of actuator 304. The data generated from these sensors can be fused or otherwise combined to create a bird-eye-view (BEV) that provides spatiotemporal information associated with the vehicle and the detected agents in the environment.

In embodiments where vehicle 300 is a fully or partially autonomous vehicle, actuator 304 may be embodied in a brake, an accelerator, a propulsion system, an engine, a drivetrain, or a steering system (e.g., steering wheel) of vehicle 300. Actuator control commands may be determined such that actuator 304 is controlled such that vehicle 300 avoids collisions with detected agents, for example. Detected agents may also be classified according to what classifier deems them most likely to be, such as pedestrians or trees. The actuator control commands may be determined depending on the classification.

In other embodiments where vehicle 300 is a fully or partially autonomous robot, vehicle 300 may be a mobile robot that is configured to carry out one or more functions, such as flying, swimming, diving and stepping, via actuator 304. The mobile robot may be an at least partially autonomous lawn mower or an at least partially autonomous cleaning robot. In such embodiments, the actuator control command may be determined such that a propulsion unit, steering unit and/or brake unit of the mobile robot may be controlled such that the mobile robot may avoid collisions with identified objects.

As presented above, the present disclosure is directed to implementing a pre-trained model configured to generate an initial HD map estimate for offline auto-labeling of ground-truth data and providing improved SD map representations for the online map generation. In some examples, the described systems and methods may include the use of real-time perception data from the various sensors 306 on the vehicle along with SD maps to generate HD maps and lane-level trajectories online (by a computing system 202 onboard the vehicle). In embodiments, the computing system 202 onboard the vehicle processes images (e.g., from one or more of a camera, LiDAR sensor, radar sensor, etc.), as well as vectorized SD map definitions represented as graphs. As a result, the computing system 202 generates, as an output, a graphical representation of the road features, lane boundaries, pedestrian crossings, road edges, surface markings, traffic lights, traffic signals detected, and their corresponding relationships indicated as modeled in the graphical representation.

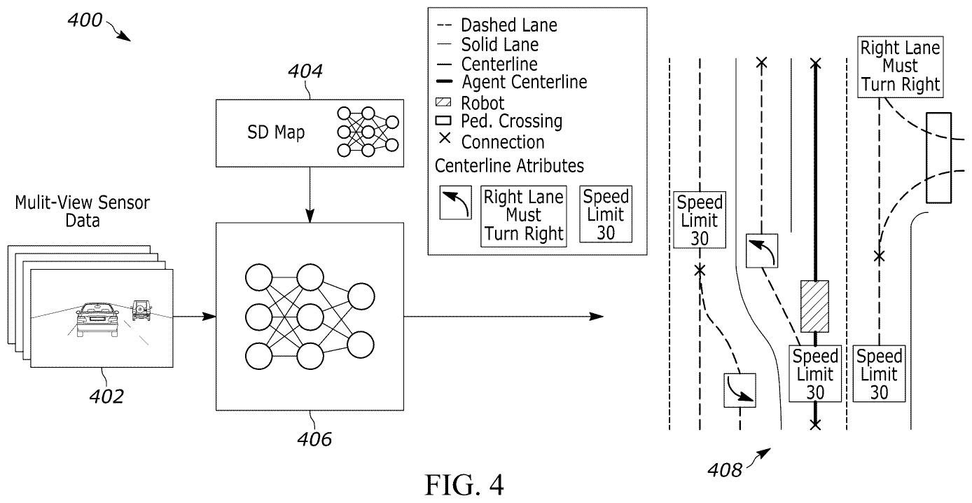

FIG. 4 shows a schematic of a system 400 for generating a HD map and lane trajectory for an autonomous vehicle based on an SD map, according to an embodiment. Sensor data from the vehicle sensors can be captured, as represented at 402. This can include images, LiDAR, radar, and the like as described above. The sensor data can be perception data associated with an environment outside the vehicle. It can also be multi-view sensor data that allows the vehicle to properly navigate in an autonomous fashion. For example, the multi-view sensor data 402 can allow for the creation of a BEV for performing autonomous driving actions. The sensor data 402 is processed by the on-board vehicle computing system, e.g., computing system 202. Doing so can allow the computing system 202 to determine the presence of pedestrians, road lane markers, other vehicles, traffic signals, and the like.

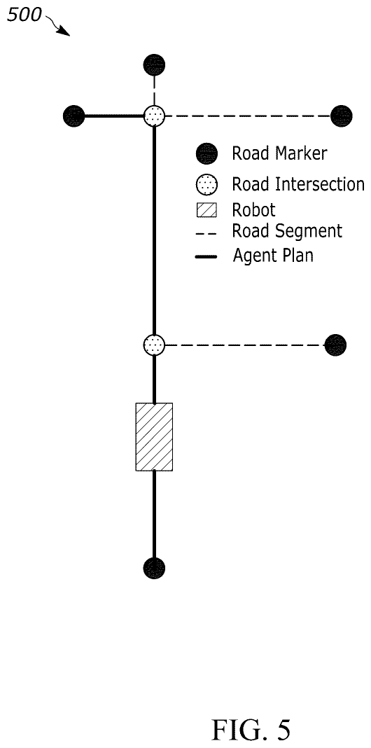

The system can also utilize a learning-based strategy to fuse the sensor data input 402 with SD map representations 404 via a fusion model 406, shown generally at 406. The SD map representations 404 can include a vectorized topological map that describes the coarse road network connectivity and includes high-level information about potential road elements such as intersections. In some embodiments, the SD map data may be vectorized, representing spatial data using vector graphics, including describing the features of a map as geometric objects like points, lines, and polygons, rather than using a raster or pixel-based representation. In other embodiments, the SD map can be rasterized, whereby the raster SD map is an image representation of an SD map. FIG. 5 shows an example of graph-based SD map representations 500 of a three-way intersection that corresponds to the driving scenario of FIG. 4 shown at 408. The SD map data can include basic information about road layout, major landmarks, and general navigation data. The SD map data is typically used in situations where the level of detail provided by HD maps is not essential, such as for traditional navigation systems (e.g., turn-by-turn) in non-autonomous vehicles. However, in examples of the present invention, the SD map data is used to create an HD map online at the vehicle. The SD map may be graph-based in that it represents the road network as a graph with nodes (vertices) and edges. In the context of a road network, the nodes can represent key points such as intersections, junctions, traffic circles, or other significant locations, while edges can represent the connections (roads) between these points. The edges may contain information about the distance, speed limits, or other relevant attributes of the road segment they represent. Navigation and path-planning algorithms can leverage graph traversal techniques to find optimal routes.

In an embodiment, the SD map data 500, 404 can be fused with the sensor data 402 at the fusion model 406, and used to generate an HD map, shown generally as an example at 408. The system selects a centerline for the vehicle (e.g., labeled “robot”) that best aligns with the autonomous agent's plan defined by the SD map. In other words, the SD map data may include a general direction on a road-level of where the vehicle should travel, and therefore the created HD map may include a planned trajectory that matches with this road-level direction except on a lane-level. The lane-level trajectory generated can be based on the detected road lane lines, predicted trajectories of other objects, and other perception and prediction model outputs. This allows the on-vehicle computing system to generate its own HD map that allows for real-time map generation of significant lane and traffic constraint features for autonomous driving actions without the need for relying on HD map data to be generated offline and transmitted to the vehicle.

SD maps provide a prior on lane topology. The vehicle's computing system then generates a trajectory that best matches what the SD map provides as a prior, but based upon the sensed objects and environment about the vehicle in real-time. The SD map can provide some high-level information about what the road might look like, and the sensor information fills in the gaps so an HD map with a lane trajectory can be generated based on the live sensor data. The lane-level information created can be used by the autonomous navigation system to control driving operation of the vehicle.

It should be understood that the SD map 404 is not required to create the HD map. Instead, the sensor data 402 can be relied upon to create the HD map online at the vehicle, without the need for the SD map. In such an embodiment, a fusion of sensor data 402 with the SD map 404 would not be required, and instead the sensor data 402 (e.g., in the form of perception data) may be utilized to create the lane-level map and lane-level trajectory.

Techniques of the present disclosure further include online generation of a centerline (e.g., a central axis of a road) and a road network map and auto-labeling for various autonomous driving applications using pre-trained neural networks. These techniques include training using both a pre-trained model and a separate, online map generation model, and can be implemented in conjunction with or independently of the techniques described above in FIGS. 4 and 5.

In a first stage, the pre-trained model is trained using large-scale sampled data (e.g. data samples extracted from worldwide SD maps and aerial images, such as satellite images). The data is composed of SD map and aerial image pairs, and, optionally, 3D trajectories obtained from other vehicles that are used to train a neural network model. For a given SD map and corresponding aerial image input, the model predicts an HD map (which may be referred to as a first or initial, offline HD map). In an example, the pre-trained model includes a large pre-trained neural network (LPNN) that can be trained using a large quantity (e.g., millions) of data samples. When applied to regions within an operational design domain (ODD), the pre-trained model can be used to generate a neural scene prior (NSP) and a pseudo-HD map an offline fashion.

In a second stage, a separate model is designed, trained, and deployed for online map generation tasks. The separate model may be referred to as an online map generation model. The online map generation model may be trained and implemented using, as inputs, surround view image data and an SD map representation (e.g., SD maps and aerial images may be optional and one or both may be provided). While the surround view image data is directly processed by the online map generation model, the SD map and aerial images are first pre-processed by using an SD map encoder of the LPNN. In various examples, LPNN network features can be generated in an offline or online fashion since SD maps and aerial images are not dependent on real-time sensor data. For efficiency, the offline NSPs may be aggregated in a unified representation to account for overlapping regions. The online map generation model is then trained for online mapping tasks such as detecting centerlines and connections, lane boundaries, pedestrian crossings, road edges, surface markings, traffic lights, and traffic signals with centerline connections. The benefit of this design is that large scale data can be incorporated to distill information and boost performance of online map generation tasks even though the task-specific dataset may be significantly smaller.

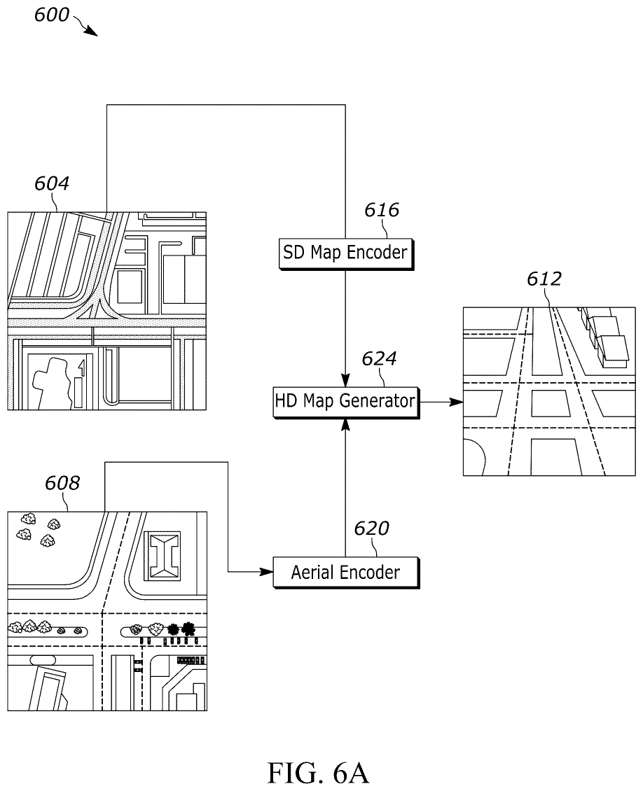

FIG. 6A shows an example system 600 configured to implement an LPNN to generate a first (initial or offline) HD map according to the principles of the present disclosure. As described herein, the system 600 is implemented offline. The system 600 is configured to process SD maps (e.g., an SD map 604) and aerial images 608 and to implement a learning-based strategy to predict lane-level HD maps (e.g., a first HD map 612).

For example, an SD map encoder 616 is configured to receive and process SD map inputs (e.g., inputs including data contained within the SD map 604). The SD map inputs may include vectorized and/or rasterized representations of SD map data. The SD map encoder 616 generates and outputs implicit SD map representations based on the SD map inputs. For example, the SD map encoder 616 implements deep learning (DL) or machine learning (ML) techniques to output SD map data in a format suitable to function as inputs to a neural network. In this manner, the SD map encoder 616 is trained to provide the SD map data (e.g., the data contained within the SD map 604) as the implicit SD map representations.

An aerial image encoder 620 operates in parallel with the SD map encoder 616. The aerial image encoder 620 is configured to receive and process aerial image data (e.g., satellite images) corresponding to the aerial images 608 (e.g., rasterized aerial image data inputs) and generate implicit representations of the aerial images 608. For example, the aerial image encoder 620 implements deep learning (DL) or machine learning (ML) techniques to output aerial image data in a format suitable to function as inputs to a neural network.

An HD map generator 624 is configured to receive and fuse the SD map representations and the aerial image representations to predict neural representations (e.g., NSPs) and generate the HD map 612 based on the NSPs. The HD map 612 can be used to automatically label new sequences of data for new regions using SD map and aerial image pairs (i.e., pairs of SD map images/representation and corresponding aerial images of a same area/map region). The SD map and aerial image pairs constitute a neural scene of a map region. In this example, the HD map generator 624 is configured to implement the LPNN to generate labels corresponding to the features contained within the SD map 604, and is trained and configured to perform prediction and reasoning tasks using the neural scene as described below in more detail.

To perform prediction tasks, the HD map generator 624 is trained to predict various elements and features in the SD map based on features in the aerial images 608. For example, the SD map 604 typically includes low-detail features such as roads and road layouts, intersections, points of interest, geographical features, etc. Conversely, the aerial images 608 may include higher-detail features such as lanes or line lines, centerlines and other lane markings, traffic lights, signs, etc. Accordingly, for a given map region of the SD map 604, the HD map generator 624 is configured to detect and identify features in a corresponding aerial image 608 and correlate the identified features to the SD map 604. In this manner, the HD map generator 624 can generate the first HD map 612 based on predicted features in the SD map 604 (e.g., by identifying, labeling, etc. features in the SD map 604 to generate the first HD map 612).

The HD map generator 624 is further trained and configured to perform reasoning tasks by predicting, based on the SD map data and the aerial image data, relationships between predicted elements and features in the first HD map 612. As one example, the HD map generator 624 may predict centerlines and other lane markings. As another example, the HD map generator 624 may predict connections between lanes and roadways, such as which lanes in a given roadway are connected to respective lanes in other roadways at different intersections (e.g., for a given intersection, which lane of a first roadway vehicles are predicted to turn onto from another lane of a second roadway). As another example, the HD map generator 624 may predict drive lines for vehicles driving on roadways depicted in the first HD map 612 (e.g., drive lines for vehicles turning from a first lane on a first roadway onto a second lane on a second roadway). Accordingly, the first HD map 612 includes additional, higher-detail features relative to the SD map 604.

FIG. 6B shows the HD map generator 624 in more detail. The HD map generator 624 includes an LPNN 628 and a map decoder 632. The LPNN 628 receives inputs such as the outputs of the SD map encoder 616 and the aerial image encoder 620 and is trained to generate labels for the features contained within the SD map 604 as described above. For example, the LPNN is trained and configured to generate one or more neural scene priors (NSPs) 636. As used herein, “neural scene priors” correspond to learned representations of features in real-world scenes, such as scenes represented by the SD map 604 and the aerial images 608. For example, the NSPs 636 are generated in accordance with a fusion of the SD map 604 and the aerial images 608. The map decoder 632 is configured to generate and output the first HD map 612 using the NSPs 636.

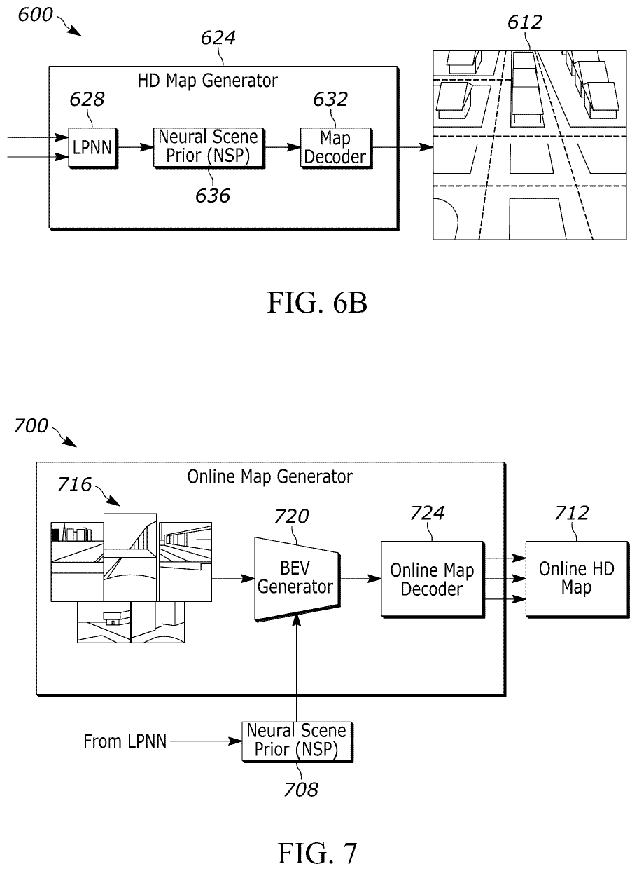

After training the LPNN 628 as described in FIGS. 6A and 6B, components of the LPNN 628 can be used to generate NSPs for new regions to provide better representations in an online task as described in FIG. 7. FIG. 7 shows an example system 700 configured to train and implement an online map generator 704 using one or more NSPs 708 according to the principles of the present disclosure (i.e., configured to perform online map generation tasks). For example, one or more of the NSPs 708 may correspond to the NSPs 636 generated in the offline task described in FIGS. 6A and 6B. In contrast to the system 600 of FIGS. 6A and 6B, the system 700 may be implemented online (e.g., in a vehicle, in real-time, etc.) and uses real-time perception data. More specifically, the system 700 is configured to generate an online (e.g., second) HD map 712 in an online manner (i.e., locally, at the vehicle, rather than receiving the HD map from a remote server or other device).

The NSPs 708 may be generated using the same SD map encoder 616, LPNN 628, etc. described in FIGS. 6A and 6B. In other words, the SD map encoder 616 used to train the HD map generator 624 offline may be reused for training and executing models in the online system 700. Further, the system 700 is configured to use the labels generated by the system 600 for online map generation. While the online task performed by the system 700 requires sensor data, the NSPs can be generated by the LPNN for any location since SD maps and aerial images are widely available.

As shown, the online map generator 704 receives inputs such as the NSPs 708 and sensor data 716 (e.g., multi-view sensor input, which may correspond to perception data), which may include camera data, and/or other image data obtained from vehicle sensors, cameras, etc. Typically, sensor data obtained from vehicle sensors is not obtained from an aerial view, and therefore the sensor data 716 may include and/or provide an indication of features not visible or detectable in aerial images. For example, the sensor data 716 may provide different perspectives of traffic lights (e.g., indicating positions of traffic lights relative to lanes), lane markings, etc. Further, the sensor data 716 is likely obtained more recently than the aerial images 608 (e.g., in real-time) and may include features not represented in the SD map 604 and the aerial images 608 (construction, new or moved features, etc.). Accordingly, the sensor data 716 may provide more recent and/or updated details relative to the SD map 604 and the aerial images 608, enabling the online map generator 704 to provide a more detailed, up-to-date online HD map 712 (i.e., relative to the first HD map 612).

In an example, the online map generator 704 includes bird's eye view (BEV) generator 720. The BEV generator 720 include one or more inputs including, but not limited to, the sensor data 716, the NSPs 708, sensor calibration data, map data (e.g., SD map data, map data corresponding to the first HD map 612, etc.), vehicle pose data and/or vehicle data, and so on. The BEV generator 720 is configured to BEV data based on the various inputs. For example, the BEV data corresponds to a 2D, top-down representation of the area around the vehicle and may include, but is not limited to, semantic segmentation, object detection, an occupancy grid, etc. In accordance with the principles of the present disclosure, the BEV data includes features represented by the sensor data 716, the NSPs 708, and/or any additional map data provided to the BEV generator 708.

The online map generator 704 (e.g., using an online map decoder 724) is configured to generate the online HD map 712 based on, at least in part, the output of the BEV generator 720. Generating the online HD map may include, but is not limited to, fusing/combining the BEV data with other data (e.g., data received from other sensors, SD and/or HD map data, LPNN data, etc.), performing feature extraction, constructing the online HD map 712, and generating and outputting the online HD map 712. In an example, the online map decoder 724 is configured to identify and output data indicating features such as traffic lights and signs, reference lines, relationships and connections between features as described herein, etc. Accordingly, the online HD map 712, similar to the first HD map 612 includes additional, higher-detail features relative to SD maps. However, in contrast to the first HD map 612, the online HD map 712 includes features that are more detailed and up-to-date in view of the sensor data 716.

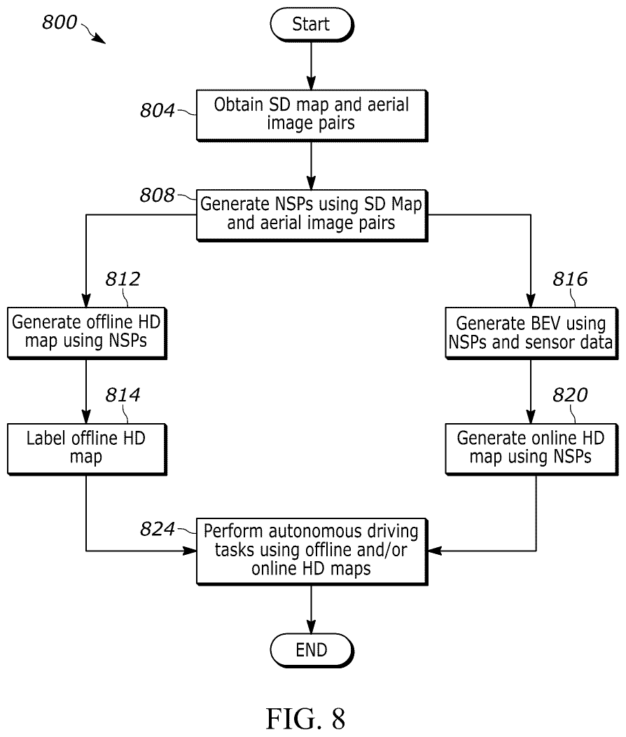

FIG. 8 illustrates steps of an example method 800 for performing HD map generation according to the principles of the present disclosure. For example, one or more processors or processing devices are configured to execute instructions to implement the method 800, such as one or more of the processors of the systems described herein. As described, the method 800 includes steps corresponding to functions performed by both the system 600 (e.g., offline HD map generation) and the system 700 (e.g., online HD map generation). However, variations of the method 800 may be used to perform only one of or both of offline and online HD map generation.

At 804, the method 800 includes obtaining one or more SD map and aerial image pairs. At 808, the method 800 includes generating one or more NSPs using the SD map and aerial image pairs (e.g., using an LPNN). For offline HD map generation, the method 800 proceeds to 812. For online HD map generation, the method 800 proceeds to 816. Although shown being performed in parallel, offline and online HD map generation functions can be formed in parallel, sequentially, in different locations and across different components/processors/vehicles, etc.

At 812, the method 800 includes generating an initial or first (offline) HD map using the NSPs. Generating the offline HD map may include storing the offline HD map in a server or other remote location accessible to vehicles, transmitting the offline HD map to one or more vehicles, etc. Generating the offline HD map may include labeling (e.g., auto-labeling) the offline HD map at 814.

At 816, the method 800 includes generating (e.g., using a BEV generator) a BEV of an environment around a vehicle using at least the NSPs and vehicle sensor data. At 820, the method 800 includes generating a second (online) HD map based at least in part on the BEV. At 824, the method 800 includes performing autonomous driving tasks using the offline and/or online HD maps.

As described above, the systems and methods described herein enable offline automatic label generation for subsequent online mapping tasks. The techniques described herein can make use of any SD maps already available without needing to collect or label new maps. Further, by reusing the SD map encoder trained and configured during the offline task, these techniques enable performance improvements by using representations learned in the offline task. Since data is reused, these techniques do not directly require sensor data from autonomous vehicle fleets. Further, widely available SD maps can be used to provide lightweight scene priors.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method of generating high definition (HD) maps for a vehicle based on standard definition (SD) maps, the method comprising, using a processor:
receiving an SD map corresponding to an environment;
receiving one or more aerial images corresponding to the environment;
predicting and labeling features contained within the SD map using at least one pairing of the SD map and a respective aerial image of the one or more aerial images;
generating a first HD map based on the predicted and labeled features contained within the SD map and the one or more aerial images; and
transmitting the first HD map to the vehicle for use in controlling autonomous driving functions.

2. The method of claim 1, wherein the first HD map is an offline map generated at a location remote from the vehicle.

3. The method of claim 1, wherein generating the first HD map includes generating the first HD map using a large pre-trained neural network (LPNN).

4. The method of claim 1, wherein generating the first HD map includes generating one or more neural scene priors (NSPs) and predicting and labeling the features based on the one or more NSPs.

5. The method of claim 4, wherein the features include at least one of lanes, line lines, centerlines or lanes, lane markings, traffic lights, traffic signs, and connections between the lanes.

6. The method of claim 5, further comprising generating a second HD map by, at the vehicle:
receiving images from one or more image sensors mounted on the vehicle;
generating perception data using the received images;
generating, using the perception data and the one or more NSPs, at least one of (i) a fused representation from sensor data and (ii) a bird's eye view (BEV) of the environment; and
generating the second HD map using the at least one of the fused representation and the BEV of the environment.

7. The method of claim 6, further comprising generating a lane-level trajectory associated with a planned route for the vehicle using the second HD map.

8. The method of claim 7, further comprising:
executing autonomous driving commands to autonomously navigate the vehicle based on the lane-level trajectory and the second HD map.

9. A system configured to generate high definition (HD) maps for a vehicle based on standard definition (SD) maps, the system comprising:
a processor configured to
receive an SD map corresponding to an environment,
receive one or more aerial images corresponding to the environment,
predict and label features contained within the SD map using at least one pairing of the SD map and a respective aerial image of the one or more aerial images,
generate a first HD map based on the predicted and labeled features contained within the SD map and the one or more aerial images, and
transmitting the first HD map to the vehicle for use in controlling autonomous driving functions.

10. The system of claim 9, wherein the first HD map is an offline map generated at a location remote from the vehicle.

11. The system of claim 9, wherein generating the first HD map includes generating the first HD map using a large pre-trained neural network (LPNN).

12. The system of claim 9, wherein generating the first HD map includes generating one or more neural scene priors (NSPs) and predicting and labeling the features based on the one or more NSPs.

13. The system of claim 12, wherein the features includes at least one of lanes, line lines, centerlines or lanes, lane markings, traffic lights, traffic signs, and connections between the lanes.

14. The system of claim 13, further comprising a second processor configured to generate a second HD map by, at the vehicle:
receiving images from one or more image sensors mounted on the vehicle;
generating perception data using the received images;
generating, using the perception data and the one or more NSPs, at least one of (i) a fused representation from sensor data and (ii) a bird's eye view (BEV) of the environment; and
generating the second HD map using the at least one of the fused representation and the BEV of the environment.

15. The system of claim 14, wherein the second processor is further configured to generate a lane-level trajectory associated with a planned route for the vehicle using the second HD map.

16. The system of claim 15, wherein the second processor is further configured to:
execute autonomous driving commands to autonomously navigate the vehicle based on the lane-level trajectory and the second HD map.

17. A non-tangible computer readable medium storing instructions that, when executed by a processor, cause the processor to generate high-definition (HD) maps for a vehicle based on standard definition (SD) maps, wherein executing the instructions causes the processor to:
receive an SD map corresponding to an environment;
receive one or more aerial images corresponding to the environment;
predict and label features contained within the SD map using at least one pairing of the SD map and a respective aerial image of the one or more aerial images;
generate a first HD map based on the predicted and labeled features contained within the SD map and the one or more aerial images; and
transmit the first HD map to the vehicle for use in controlling autonomous driving functions.

18. The non-tangible computer readable medium of claim 17, wherein the first HD map is an offline map generated at a location remote from the vehicle.

19. The non-tangible computer readable medium of claim 17, wherein generating the first HD map includes generating the first HD map using a large pre-trained neural network (LPNN) to generate one or more neural scene priors (NSPs) and predicting and labeling the features based on the one or more NSPs.

20. The non-tangible computer readable medium of claim 19, wherein executing the instructions causes a second processor to generate a second HD map by, at the vehicle:
receiving images from one or more image sensors mounted on the vehicle;
generating perception data using the received images;
generating, using the perception data and the one or more NSPs, at least one of (i) a fused representation from sensor data and (ii) a bird's eye view (BEV) of the environment; and
generating the second HD map using the at least one of the fused representation and the BEV of the environment.
